(19) United States
(12) Patent Application Publication
(10) Pub. No.: US 2013/0280487 A1
(43) Pub. Date: Oct. 24, 2013

(54) METHOD FOR PREPARING TEXTURED DECORATIVE GLASS

(71) Applicant: John Scott Blazy, Parma, OH (US)

(72) Inventor: John Scott Blazy, Parma, OH (US)

(73) Assignee: DICHROLAM, LLC, Parma, OH (US)

(21) Appl. No.: 13/453,233

(22) Filed: Apr. 23, 2012

(51) Int. Cl. B32B 3/30; B32B 38/10

(52) U.S. Cl. 428/142; 156/220; 428/141

(57) ABSTRACT

The present invention is directed generally to a method of preparing textured glass, namely decorative glass and/or dichroic glass. The present method may also allow the bonding of an additional substrate to the textured glass, textured decorative glass, and/or textured dichroic glass. A glass, decorative glass, and/or dichroic glass that can be textured, laminated, and fully protective may also be provided from the present method described herein.

### I. BACKGROUND OF THE INVENTION

A. Field of Invention

The present invention is directed generally to a method of preparing textured glass, namely decorative glass and/or dichroic glass. The present method may allow the bonding of an additional substrate to the textured glass, textured decorative glass, and/or textured dichroic glass. A glass, decorative glass, and/or dichroic glass that can be textured, laminated, and fully protective may also be provided from the present method described herein.

B. Description of the Related Art

Glass has been used decoratively in a multitude of ways. One decorative glass that may be used is dichroic glass, which literally means “two colored” and is derived from the Greek words “di” for two, and “chroma” for color. The decorative effect involves varying color patterns resulting from dichroic materials coated on an uneven surface of a glass body. The dichroic materials transmit or reflect different colors of light, and the unevenness of the coated surface imposes patterns on the colors of light that are transmitted or reflected. Depending on the incident of light and the viewing angle, it appears to have more than one color at the same time. This is due to the nature of dichroic glass, which allows some wavelengths of light and color to reflect while other wavelengths pass through, producing a shifting pattern effect in which the color of the glass changes with the amount of light being absorbed or reflected. Besides the multi-colored feature, it may or may not have reflective properties.

Dichroic glass does not use paints, dyes, or any other kind of coloring agent to create its color, but sometimes pieces of colored glass are coated. The coating itself doesn't have its own inherent color, but rather it bends light to reflect colors exactly as a prism makes rainbows. With so many combinations of glass colors and patterns available to make dichroic glass, endless possibilities are available for different colors and patterns. Making dichroic glass requires a complex processing technique and is only made by a handful of manufacturers that have equipment like high temperature vacuum chambers, vaporizing electro-guns, and high temperature kilns. Dichroic glass may provide completely new effects, as special films with changing colors are combined with glass. Through combinations with various glass types and special films used within the processing of dichroic glass, an unlimited number of different appearances can be created.

Earlier types of rudimentary dichroic glass date back to at least the 4^{th} century AD. Besides its use for decorative purposes, this type of glass has been used in the aerospace industry. Modern versions off dichroic glass were developed in the late fifties by NASA to protect against the potentially harmful effects of direct sunlight and cosmic radiation. Dichroic glass, with its striking visual qualities, has been used in a variety of scientific and industrial applications. It has had applications for use in satellite mirrors and re-entry tiles on space shuttles. It has also been modified to provide dichroic safety glass, which may be used in architectural applications. This safety glass is typically a laminated, flat, non-textured dichroic glass which can provide decorative properties. This dichroic glass can be both marketed as a safety glass and simultaneously provide decorative properties.

Even though the dichroic glass can be made into safety glass, its appearance does not provide all of the possibilities available from dichroic glass. While current safety dichroic glass typically is flat and non-textured, its potential decorative use is reduced. One alternative in the marketplace is a dichroic glass in which the texture is applied to one side only by a single pane of glass or another substrate. However, the flat dichroic laminated safety glass more commonly found is not as aesthetically pleasing as a textured dichroic glass, and the flat dichroic laminated safety glass may also have the additional disadvantage of having a high minor reflectance, which can provide an objectionable blinding glare. Additionally, the flat dichroic laminated glass may unfortunately provide distorted optical image transmission clarity.

The present invention pertains to the field of decorative glass. The invention provides methods for preparing a textured, laminated, and fully protective dichroic glass and other decorative glass. More particularly, the invention may pertain to decorative glass blocks, glass tiles, and glass panels as well as other applications including but not limited to architectural applications, lighting fixtures, skylights, mosaics, sconces, sculpture, stained glass, optical filters, and/or jewelry that use dichroic glass.

### II. SUMMARY OF THE INVENTION

Accordingly, it is an object of the invention to provide a method of preparing textured dichroic glass or other textured glass. It may include the steps of providing a substantially flat substrate; applying a bonding film to the substantially flat substrate; applying a decorative film to the bonding film; applying a flat form plane to the decorative film; removing the flat form plane; applying a textured glass surface; setting a pattern within the bonding film and the decorative film; and removing the textured glass surface wherein a glass having an impressed pattern is formed.

According to another object of the present invention, the textured glass comprises at least one glass of clear glass, colored glass, and dichroic glass.

According to one object of the present invention, the substantially flat substrate comprises glass.

According to another object of the present invention, the bonding film comprises heat curable bonding film.

According to one object of the present invention, the bonding film comprises a thermoplastic bonding film.

Another to still another object of the present invention, the bonding film comprises at least one bonding film of ethylene vinyl acetate, acrylic, ethylene copolymer, ethylene/methacrylic acid copolymer, ethylene-acrylic acid copolymer, polyvinyl butyrol, polyester, polyimide, nitrile phenolic, and epoxy.

According to yet another object of the present invention, the bonding film further comprises a crosslinking agent.

According to still another object of the present invention, the decorative film comprises at least one film of single colored films, multicolored films, acetate films, metal foils, polyethylene terephthalate films, and holographic films.

According to yet another object of the present invention, the process may further comprise the step of adding a plurality of decorative films wherein the decorative films are interposed by the bonding films.

According to still another object of the present invention, the process may further comprise the step of applying heat between the substantially flat substrate and the flat form plane after applying the flat form plane to the decorative film.

According to still yet another object of the present invention, the process may further comprise the step of removing air between the substantially flat substrate and the flat form plane during the step of applying heat.

According to another object of the present invention, the process may further comprise the step of applying heat during the step of setting a pattern within the bonding film and the decorative film.

According to one object of the present invention, the process may also include applying at least one bonding film and an additional substrate panel onto the surface of the glass having an impressed pattern and bonding at least one bonding film and additional substrate panel onto the surface of the glass having an impressed pattern. The process may further include applying heat and removing air during the step of bonding at least one bonding film and additional substrate panel onto the glass having an impressed pattern and applying pressure during the step of bonding at least one bonding film and additional substrate panel onto the glass having an impressed pattern.

According to another object of the present invention, the additional substrate panel comprises at least one substrate panel of glass, metal, stone, and plastic.

According to still another object of the present invention, the process may further comprise the step of adding at least one protective glass pane.

According to still another object of the present invention, the process further comprises the step of providing safety glass.

According to still yet another object of the present invention, the process further comprises the step of reducing reflectance.

According to yet another object of the present invention, the process further comprises the step of providing nondistorted optical image transmission clarity.

According to another object of the present invention, the process may comprise making textured glass, comprising the steps of: providing a substantially flat substrate comprising glass; applying a bonding film comprising ethyl vinyl acetate to the substantially flat substrate; applying a decorative film comprising metal foil or dichroic film to the bonding film; applying a flat form plane to the decorative film; applying heat to the bonding and decorative film layers between the substantially flat substrate and the flat form plane; removing air from the bonding and decorative film layers between the substantially flat substrate and the flat form plane; removing the platform plane; applying a textured glass surface; applying heat and setting a pattern within the bonding film and the decorative film; and removing the textured glass surface. The process may further comprise the step of adding a plurality of decorative films wherein the decorative films are interposed by the bonding films.

According to another object of the present invention, a textured glass may be prepared by a process comprising the steps of providing a substantially flat substrate; applying a bonding film to the substantially flat substrate; applying a decorative film to the bonding film; applying a flat form plane to the decorative film; removing the flat form plane; applying a textured glass surface; setting a pattern within the bonding film and the decorative film; and removing the textured glass surface.

According to still another object of the present invention, a textured glass may be further prepared by adding a plurality of the decorative films wherein the decorative films are interposed by the bonding films.

According to still yet another object of the present invention, a textured glass may be further prepared by applying at least one bonding film and an additional substrate panel onto the textured glass surface and bonding at least one bonding film and the additional substrate panel onto the textured glass surface.

According to still yet another object of the present invention, a textured glass may be further prepared by adding at least one protective glass pane.

Further, another object of the present invention can be to provide a method for preparing textured dichroic glass that is easy to implement and use.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, a preferred embodiment of which will be described in detail in this specification and illustrated in the accompanying drawings which form a part hereof and wherein:

FIG. 1 is a diagram schematically illustrating the present invention.

FIG. 2 is a diagram schematically illustrating the present invention.

FIG. 3 is a diagram schematically illustrating the present invention.

FIG. 4 is a diagram schematically illustrating the present invention.

FIG. 5A is a diagram schematically illustrating the present invention.

FIG. 5B is a diagram schematically illustrating the present invention.

FIG. 6 is a diagram schematically illustrating the present invention.

FIG. 7 is a diagram schematically illustrating the present invention.

### IV. DETAILED DESCRIPTION OF THE INVENTION

Referring now to the drawings wherein the showings are for purposes of illustrating embodiments of the invention only and not for purposes of limiting the same, the figures shown provide steps for the process described herein.

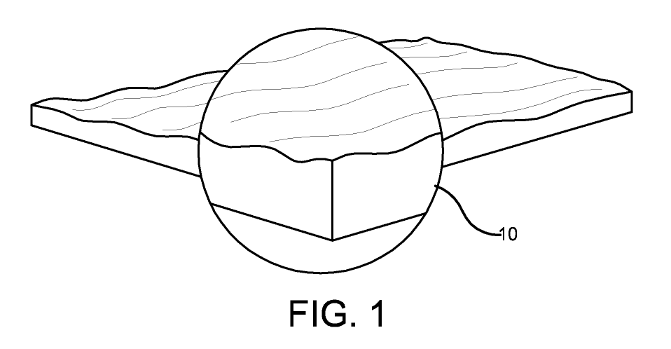

FIG. 1 shows a textured substrate 10 which may be used in the process described herein. Although a textured substrate 10 may be glass, a textured substrate may be a patterned heat-stable plastic, plastic composite, patterned concrete, patterned steel, patterned metal surface, or any combination thereof. A textured substrate 10 may be any material which may be heat stable and can retain its shape if subjected to vacuum and/or heat. The textured substrate 10 or any of the other substrates may be used to provide a pattern to a substantially flat substrate like glass, forming a textured glass.

If a textured substrate 10 to be used is glass, the types of glass may include flat glass, optical glass, fiberglass, laminated safety glass, bullet-resistant glass, tempered safety glass, colored structural glass, opal glass, foam glass, glass-building blocks, heat-resistant glass, glass ceramics, radiation-absorbing and radiation-transmitting glass, laser glass, invisible glass, photochromic glass, photosensitive glass, heavy metal fluoride glass, chalcogenide glass, and sol-gel glass. The patterned glass may contain a multitude of textures and patterns, with a large number of styles available both commercially and through custom glass makers. The textured and patterned glass product offerings may come from many patterned and cast glass suppliers. Additionally, flat glass with silicone, wood, and/or other substrate patterns bonded to the flat glass to create the textured impression panel may be used.

For the textured substrate 10, the peak(s) of the texture and/or pattern(s) may be about 0.003 inches to about 0.450 inches. The peak(s) of the texture and/or pattern(s) may be consistent in peak height across the entire surface. The textured substrate 10 may be provided in any thickness and any size. The textured substrate 10 may be any texture and/or any pattern for the process described herein.

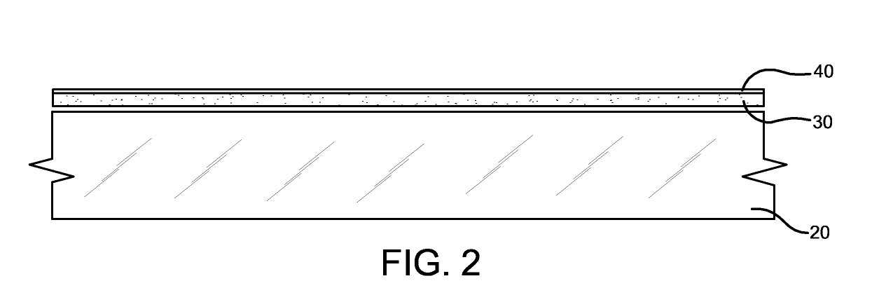

FIG. 2 shows the preparation of a substantially flat substrate 20 with at least one bonding film 30 and at least one decorative film 40. In the cross-section shown in FIG. 2, at least one bonding film 30 may be applied to the substantially flat substrate 20, and at least one decorative film 40 may be applied to a bonding film 30.

A substantially flat substrate 20 may be comprised of glass, plastic, steel or other metal, and/or concrete. The substantially flat substrate 20 may be chosen such that a texture will be added to it. A substantially flat substrate 20 may be any thickness.

A bonding film 30 may be a film. A bonding film 30 may be used for bonding to a substrate, specifically a substantially flat substrate 20 like a glass substrate, and/or a decorative film 40. A bonding film 30 may be a clear film. A bonding film 30 may essentially be sheets of hot melt adhesive. A bonding film 30 may also be heat curable. A bonding film 30 may be a thermoplastic film. A bonding film 30 may be comprised of at least one bonding film 30 of ethylene vinyl acetate, acrylic, ethylene copolymer, ethylene/methacrylic acid copolymer, ethylene-acrylic acid copolymer, polyvinyl butyrol, polyester, polyimide, nitrile phenolic, and epoxy. The ethylene/methacrylic acid copolymers may contain small amounts of metal salts, which can also be referred to as an Ionoplast layer. A bonding film 30 may also contain at least one crosslinking agent. These crosslinking agents may provide thermally triggered hardeners which can be built into the films. Using crosslinking agents within the bonding film 30 may create a nonreversible permanent polymer that cannot be melted, therefore keeping the textured shape.

A decorative film 40 may provide the desired effects for the end-product. A decorative film 40 may be thin or thick layers. A decorative film 40 may be comprised of a film or any other form that may provide a decorative effect. The decorative film 40 may be clear, colored (like theater lighting gels), holographic, or dichroic films. A decorative film 40 may comprise at least one film of single colored films, multicolored films, acetate films, metal foils, polyethylene terephthalate films, dichroic films, and holographic films.

The decorative film 40 may provide unlimited possibilities as to the desired effect of the end-product. The colored films may be acetate or vinyl films. The holographic films may be comprised of polyethylene terephthalate. If a dichroic film is used, it may provide an effect in which it may change color based on the viewing angle in both reflected light color and transmitted light color. The dichroic films may be multi-layer co-extruded polymer films that create light interference through a high number of internal layering, which create light filtering through “thin film physics.”

The number of bonding film(s) 30 and decorative film(s) 40 may be determined by a desired end-product appearance. The number of bonding film(s) 30 and decorative film(s) 40 may also be determined by the desired thickness of the end-product. The number of bonding film(s) 30 and decorative film(s) 40 may be only about one of each or as many as about eight of each. If more than one decorative film 40 is to be used, then the decorative film 40 layers may be interposed by at least one bonding film 30. The figures shown only depict one bonding film 30 and one decorative film 40.

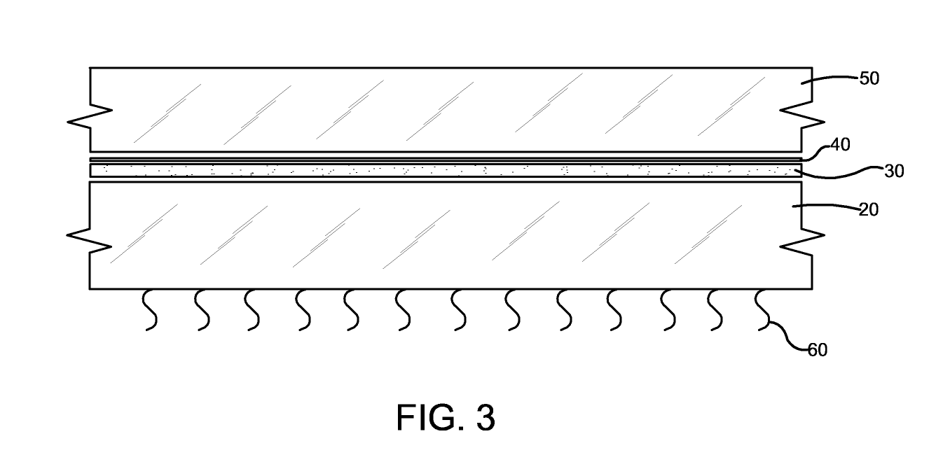

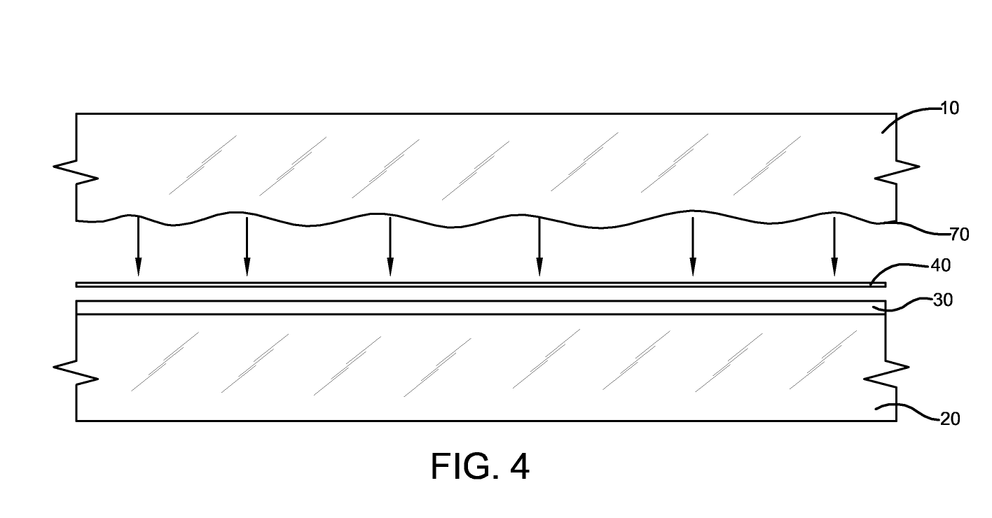

FIG. 3 shows the addition of a flat form plane 50. A flat form plane 50 may be comprised of glass and/or another substrate. The process shown in FIG. 3 may affix the bonding film 30 and decorative film 40 onto the substantially flat substrate 20. In this step, a heat source 60 may be used. A heat source 60 may be added to the substantially flat substrate 20. This heat source 60 may provide softening temperature levels, but not to temperatures high enough to initiate the crosslinking agent(s) in the bonding film(s), if present. A heat source 60 may range from about 75 degrees Celsius to about 130 degrees Celsius. A heat source 60 may range from about 75 degrees Celsius to about 130 degrees Celsius. A heat source 60 may range from about 65 degrees Celsius to about 95 degrees Celsius. This step may serve to pre-melt the bonding film(s) 30 into an optically clear, molten, polymer state which can be ready to receive the textured surface 70 of the textured substrate 10, which can be shown in FIG. 4.

In FIG. 3, the optional step of removing the air between the substantially flat surface 20, like a glass surface, and a flat form plane 50 may occur. The air may be removed after a flat form plane 50 is placed on top of the decorative film 40. The air may then be removed from a bonding film 30 and a decorative film 40, or a plurality of bonding films 30 and decorative films 40. Removing the air may increase the optical clarity within the glass. If the air is not removed using this step, there may be air bubbles within the end-product glass having an impressed pattern. These air bubbles, if not removed, may be a desired effect.

The optional step of removing air between the substantially flat surface 20 and a flat form plane 50 may occur in a vacuum laminating oven. A vacuum laminating oven can be a furnace combined with a membrane vacuum to heat and melt-bond a bonding film 30 and a decorative film 40, or multiple layers of bonding films 30 and decorative films 40, between the substantially flat surface 20 and a flat form plane 50 while under a vacuum pressure. A vacuum pressure may be about 300 millimeters of mercury to about 800 millimeters of mercury. The use of a vacuum laminating oven may provide production efficiencies.

The substantially flat surface 20, the bonding film(s) 30, the decorative film(s) 40, and the flat form plane 50 can be subjected to a heat source 60 within the vacuum laminating oven. This step may also serve to de-air the bonding film(s) 30.

After the prepared substrate undergoes de-airing, it may create a finished, bonded, laminated glass. This finished, bonded, laminated glass may be certified safety glass.

FIG. 4 shows the removal of the flat form plane 50 after the application of a heat source 60 and the placement of a textured surface 70. This textured surface 70 may comprise at least one textured surface of glass, silicone-textured glass, steel, cast iron, medium density fiberboard, medium density fiberboard-laminated glass, plaster, composites of plaster and glass, concrete, composites of concrete and glass, moulded silicone rubber, and fiberglass resin carbon fiber. The textured surface 70 of the textured substrate 10 may come into contact with a decorative film 40. This placement of a textured surface 70 down may be such that the textured surface can be imprinted onto a bonding film 30 and a decorative film 40, or multiple layers of bonding films 30 and decorative films 40.

When the bonding film(s) 30 and the decorative film(s) 40 are placed on the substantially flat substrate 20, the textured surface 70 of the textured substrate 10, as described in FIG. 1, will create and impress its texture onto the bonding film(s) 30 and the decorative film(s) 40. The texture(s) imprinted can provide certain effects in the end-product, namely a pattern impressed glass.

This texturing process, wherein the substrate has been heated and may have been subjected to a de-airing process, as described in FIG. 3, may occur. A vacuum can then also be used to impress the texture onto the decorative film(s), which may include dichroic film. A vacuum pressure may be about 300 millimeters of mercury to about 800 millimeters of mercury.

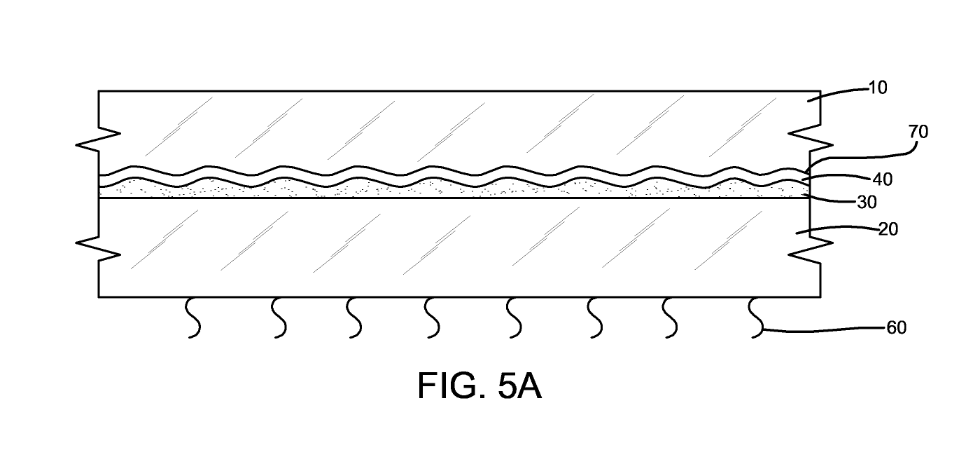

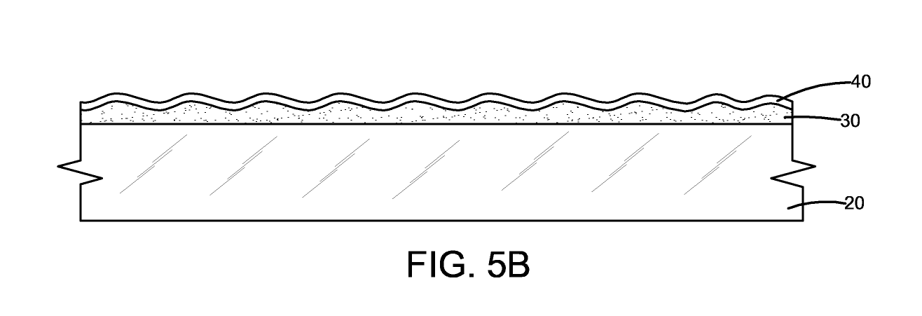

FIG. 5A shows a process in which a pattern may be set into the molten decorative and bonding films. Besides the vacuum pressure described in FIG. 4, a pattern may also be set into the molten film layers using a higher temperature with a sufficient time to permanently impress the pattern and/or texture in a non-reversible process, meaning the bonding film(s) 30 and decorative film(s) 40 cannot be remelted to provide another texture onto the textured panel end-product. This increased temperature from a heat source 60 may be about 75 degrees Celsius to about 130 degrees Celsius. This increased temperature from a heat source 60 may be about 65 degrees Celsius to about 95 degrees Celsius. This temperature increase from a heat source 60 may initiate reactions, including possible crosslinking reactions, within the bonding film(s) 30 and decorative film(s) 40, which can then set the impressed texture.

If no flat form plane 50 is used, as described in FIG. 3, then shallower textures may be formed. Without the de-airing procedure with the flat form plane 50, the textured surface 70 may be placed directly onto the substantially flat surface 20, the bonding film(s) 30, and the decorative film(s) 40, which may result in an optically clear, molten polymer state while impressing the textured surface 70 in a limited number of steps.

However, if a pre-heat is added to the flat form plane 50 and placed on the substantially flat surface 20, the bonding film(s) 30, the decorative film(s) 40, as described in FIG. 3, then deeper textures may be created.

Using the processes described herein, some decorative films 40 like clear polyethylene terephthalate and acetate may provide visually identical glass to typical textured glass. The process described herein may allow for a multitude of thicknesses, types, colors, designs, and configurations for any architectural requirements. The process described herein may also provide a mirror finish.

FIG. 5B provides the removal of the textured surface 70 from the substantially flat surface 20, the bonding film(s) 30, and the decorative film(s) 40. After the removal, a permanently textured surface can be formed.

Additionally, the finished panel may be certified safety glass. This certified safety glass may now be qualified as CPSC 16 CFR1201 Category II certified safety glass, which may pass ANSI Z 97 impact tests. Certified safety glass may be specified in architectural or other applications that may require this certification or where federal law mandates its use. Also, the process described may provide reduced reflectance and nondistorted optical image transmission clarity when compared to other forms of textured decorative glass.

Furthermore, the textured side face of the pane of glass may be edge-bonded to protect it from damage. This may be achieved by making the glass panel into an insulated glass unit where the edge can be bonded with insulating spacers. Further, at least one protective glass pane may also be added after this step.

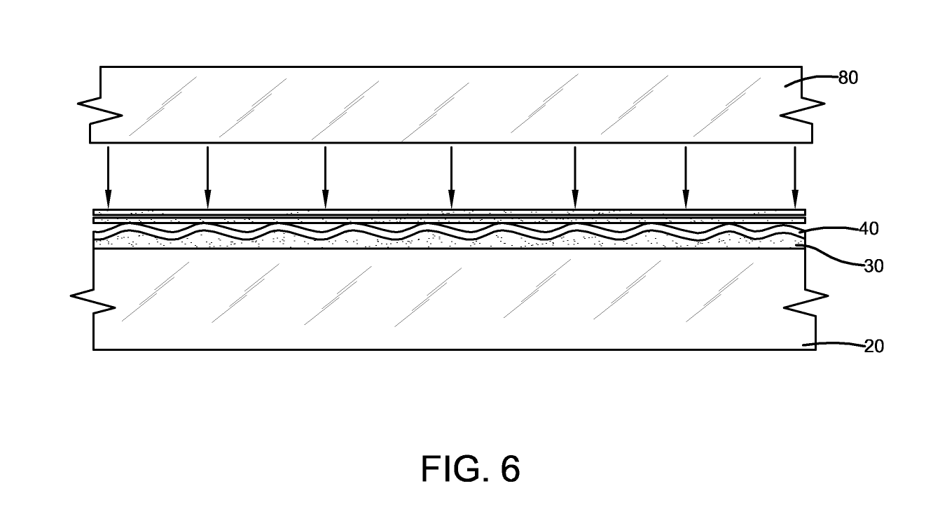

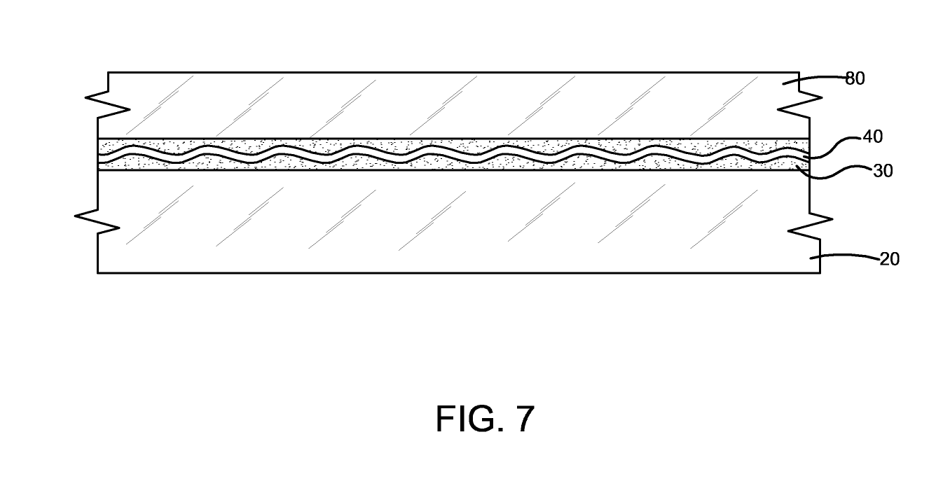

FIG. 6 shows an optional step where an additional panel of glass or other substrate 80 can be placed over the permanently textured glass or other substrate as described in FIGS. 5A and 5B. The additional panel may be comprised of at least one substrate panel of glass, metal, stone, and plastic. During this optional step, an additional panel of glass or other substrate 80 may be laminated onto the textured side of the panel, which may occur by placing at least one bonding film 30 onto the textured side of the permanently textured glass or other substrate as described in FIGS. 5A and 5B. For deeper textures, a plurality of bonding films 30 may be added to the textured side of the panel, whereas fewer layers may be used for shallower textures. The additional panel of glass or other substrate 80 may be secured and bonded through the use of heat and/or pressure onto the textured side in order to prevent shifting during the lamination process, which is described in detail in FIG. 7.

FIG. 7 shows a lamination step for additional panel of glass or other substrate 80 as described in FIG. 6. Within the lamination step, the additional panel of glass or other substrate 80 may be placed into a vacuum lamination oven to be processed. Within the vacuum lamination oven, the air may be removed between the panels. Heat may also be applied. A vacuum pressure may be about 300 millimeters of mercury to about 800 millimeters of mercury. The temperature may be about 75 degrees Celsius to about 130 degrees Celsius. The temperature may be about 75 degrees Celsius to about 130 degrees Celsius. The temperature may be about 65 degrees Celsius to about 95 degrees Celsius. Because the texture applied in FIGS. 5A and 5B has been set, the final lamination step can conform to the contours and/or textures of the glass having a permanently impressed pattern.

The additional steps as described in FIGS. 6 and 7 can provide an optical clarity through the texture and may assist in protecting the textured layer by encapsulation. This optical clarity may provide a distinctness of image through both the glass and the texture imprinted in the bonding film(s) 30 and decorative film(s) 40. Additionally, these steps may provide increased durability of the permanently textured glass or other substrate, which can also provide certified safety glass. When the additional steps as described in FIGS. 6 and 7 are completed, the textured layer(s) may be fully protected from damage. Further, at least one protective glass pane may also be added after the additional steps described in FIGS. 6 and 7.

Besides the process described herein, a textured glass product may be prepared by a process comprising the steps of providing a substantially flat substrate; applying a bonding film to the substantially flat substrate; applying a decorative film to the bonding film; applying a flat form plane to the decorative film; removing the flat form plane; applying a textured glass surface; setting a pattern within the bonding film and the decorative film; and removing the textured glass surface. In addition to these steps, a textured glass product may be prepared further by adding a plurality of decorative films where the decorative films are interposed by the bonding films. Further, the textured glass described using the process above may also have at least one bonding film and an additional substrate bonded to the textured glass product. Besides the process described above, at least one protective glass panel may be added to the textured glass product.

The embodiments have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

1. A process of making textured glass, comprising the steps of:
providing a substantially flat substrate;
applying a bonding film to said substantially flat substrate;
applying a decorative film to said bonding film;
applying a flat form plane to said decorative film;
removing said flat form plane;
applying a textured surface;
setting a pattern within said bonding film and said decorative film; and
removing said textured surface;
forming glass having an impressed pattern.

2. The process of claim 1, wherein said substantially flat substrate comprises glass.

3. The process of claim 1, wherein said bonding film comprises heat curable bonding film.

4. The process of claim 1, wherein said bonding film comprises a thermoplastic bonding film.

5. The process of claim 1, wherein said bonding film comprises at least one bonding film of ethylene vinyl acetate, acrylic, ethylene copolymer, ethylene-acrylic acid copolymer, ethylene/methacrylic acid copolymer, polyvinyl butyrol, polyester, polyimide, nitrile phenolic, and epoxy.

6. The process of claim 1, wherein said decorative film comprises at least one decorative film of single colored films, multicolored films, acetate films, metal foils, polyethylene terephthalate films, and holographic films.

7. The process of claim 1, further comprising the step of adding a plurality of said decorative films wherein said decorative films are interposed by said bonding films.

8. The process of claim 1, further comprising the step of applying heat between said substantially flat substrate and said flat form plane after applying said flat form plane to said decorative film.

9. The process of claim 9, further comprising the step of removing air between said substantially flat substrate and said flat form plane during said step of applying heat.

10. The process of claim 1, further comprising the steps of:
applying heat during said step of setting a pattern within said bonding film and said decorative film; and
impressing said textured surface into said bonding film and said decorative film.

11. The process of claim 1, wherein said textured surface comprises at least one textured surface of glass, silicone-textured glass, steel, cast iron, medium density fiberboard, medium density fiberboard-laminated glass, plaster, composites of plaster and glass, concrete, composites of concrete and glass, moulded silicone rubber, and fiberglass resin carbon fiber.

12. The process of claim 1, further comprising the steps of:
applying at least one bonding film and an additional substrate panel onto said glass having an impressed pattern; and
bonding said at least one bonding film and said additional substrate panel onto said glass having an impressed pattern.

13. The process of claim 12, wherein said additional substrate panel comprises at least one substrate panel of glass, metal, stone, and plastic.

14. The process of claim 12, further comprising the steps of:
applying heat during said step of bonding said at least one bonding film and said additional substrate panel onto said glass having an impressed pattern; and
applying pressure during said step of bonding said at least one bonding film and said additional substrate panel onto said glass having an impressed pattern.

15. The process of claim 1, further comprising the step of adding at least one protective glass pane.

16. The process of claim 1, further comprising the step of providing safety glass.

17. The process of claim 1, further comprising the step of reducing reflectance.

18. The process of claim 1, further comprising the step of providing nondistorted optical image transmission clarity.

19. A process of making dichroic glass, comprising the steps of:
providing a substantially flat substrate comprising glass;
applying a bonding film comprising ethyl vinyl acetate to said substantially flat substrate;
applying a decorative film comprising metal foil or dichroic film to said bonding film;
applying a flat form plane to said decorative film;
applying heat between said substantially flat substrate and said flat form plane;
removing air between said substantially flat substrate and said flat form plane;
removing said platform plane;
applying a textured glass surface;
setting a pattern within said bonding film and said decorative film;
applying heat during said step of setting a pattern; and
removing said textured glass surface;
forming glass having an impressed pattern.

20. A textured glass prepared by a process comprising the steps of:
providing a substantially flat glass substrate;
applying a bonding film to said substantially flat glass substrate;
applying a decorative film to said bonding film;
applying a flat form plane to said decorative film;
removing said flat form plane;
applying a textured surface;
setting a pattern within said bonding film and said decorative film; and
removing said textured surface.

21. A textured glass prepared by the process of claim 20, further comprising the step of adding a plurality of said decorative films wherein said decorative films are interposed by said bonding films.

22. A textured glass prepared by the process of claim 20, further comprising the steps of:
applying at least one bonding film and an additional substrate panel onto said textured glass; and
bonding said at least one bonding film and said additional substrate panel onto said textured glass.

23. A textured glass prepared by the process of claim 20, further comprising the step of adding at least one protective glass pane.
